(19) United States
(12) Patent Application Publication
(10) Pub. No.: US 2004/0111932 A1
(43) Pub. Date: Jun. 17, 2004

(54) Protector for vehicle license plates

(75) Inventors: John H. Lee, Olathe, KS (US); Angela J. Lee, Olathe, KS (US)

Correspondence Address: John H. Lee, 1441 N Lucy Montgomery Way, Olathe, KS, 66061, US

(73) Assignee: Rigel Technology Corporation, Shawnee, KS

(21) Appl. No.: 10/618,813

(22) Filed: Jul. 14, 2003

Related U.S. Application Data
(63) Continuation-in-part of application No. 10/318,941, filed on Dec. 16, 2002.

(51) Int. Cl. G09F 7/00

(52) U.S. Cl. 40/200

(57) ABSTRACT

A practical and non-expensive method for protecting a vehicle license plate from being stolen is provided. The vehicle license plate protection comprises a protector and holder. Either or both protector and holder have the function to be pressed and expanded. The protector and holder are held each other after the pressed or/and expanded parts return. The protector is screwed or pushed through the hole on a vehicle license plate and into the holder or hole on a vehicle body to hold the protector, plate and holder together. The protector and vehicle license plate can not be taken out by screwing or pulling out for protecting the plate from being stolen. The cost of the protector for a vehicle license plate protector is low. The method provides a practical and economical protection for automobile industry and vehicle customers to protect vehicle license plates.

### CROSS-REFERENCE TO RELATED APPLICATION

This application is a continuation-in-part application of U.S. application Ser. No. 10/318,941, filed Dec. 16, 2002.

### BACKGROUND OF THE INVENTION

This present invention relates to a practical method for a vehicle license plate protection at very low cost by a protector and holder. The protector is pushed or screwed through the hole on an vehicle license plate and into the holder. The holder may be an additional holder, the existing or new hole or screw holder in the location for a license plate on a vehicle body. The protector and the holder are coupled or connected each other for holding and protecting the vehicle license plate, which can not be taken out with a normal tool such as screw driver from outside of the vehicle body.

A vehicle license plate is mounted to the license plate location on a vehicle body by two or four screws currently for cars, trucks, motorcycles and other vehicles. There are four holes, which are such as about 5/16 inch diameter, on a normal vehicle license plate. The license plate screws, which are such as about ¼ inch diameter, are pushed through the holes on the vehicle license plate and screwed into the screw holders or holes on a vehicle body. The plate usually locates in central areas in the back side of a vehicle body. The screws are also very easy to be taken out with a common tool such as a screw driver from the outside of the vehicle body.

Several US patents relating vehicle license plates have been issued over years. U.S. Pat. No. 6,582,314 discloses a novelty device to attach to the vehicle between a license plate mounting. area and the license plate. U.S. Pat. No. 6,481,126 discloses a lockable license plate holder for securing a license plate via a plurality of the conventional fasteners and a locking unit including a lock member. U.S. Pat. No. 6,286,238 discloses security system for a license plate, vanity plate or tag includes a bracket for mounting on a vehicle and a lockable frame interfitting therewith. Locking is achieved between the frame and bracket. U.S. Pat. No. 6,254,302 discloses a holding element and plate member including elastic holding element mounting region. In one form, the elastic region includes a holding zone. In another form, the elastic region is formed by a pair of elongate resilient arms that disposed on opposite sides of the elastic region. U.S. Pat. No. 5,845,584 discloses a bridge plate assembly for use in moving vehicles between rail cars for loading and unloading has sufficient length to span the space between adjacent rail cars and has sufficient width to accommodate vehicles of varying wheelbase. U.S. Pat. No. 5,428,911 discloses a mountable display apparatus for surrounding the edges of a vehicle identification plate mounted within the plate well of a vehicle. The frame is flexible and larger than the plate well. U.S. Pat. No. 5,150,960 discloses a vehicle illumination device for a license plate that includes a frame enclosing a clear plastic wedge which serves as a light pipe for a light source placed along one edge of the clear plastic wedge. U.S. Pat. No. 4,4924,611 discloses a frame comprising upper, lower, and side bars outlines a space to display a license plate. U.S. Pat. No. 4,813,167 discloses an apparatus for removably fastening a cover plate cover a vehicle's existing license plate. When a cover plate for a license plate is so mounted, it is placed in a relation with respect to the license plate. U.S. Pat. No. 4,001,822 discloses an electronic licensed plate including a single antenna system.

Vehicle license plates are easy to be held by screwing the license plate screws into the existing screw holders or holes on vehicle bodies currently. The screws and plates are also very easy to be taken out with a normal tool such as a screw driver. The license plates are stolen easily, which happens in public parking lots and at night time. It gives inconvenience to the vehicle owners and drivers after it happens. There is a need to have a protection for vehicle license plates. Also the cost should be low enough for people to use the protection for their vehicle license plates.

### DESCRIPTION OF THE INVENTION

The present invention provides a practical and economical protection to protect the license plates, the plate frames and the cover plates for vehicles and other plates. The plates can not be taken away by the normal methods such as by a screw driver from the outside of the vehicle body. When the vehicle license plate is needed for change, the connection between the protector and its holder needs to be released at first. Then the protector is screwed or pulled out. The protector may be used again for new vehicle license plate.

The principle of the protection is to hold the protector with its holder and to release the protector from the holder. When the protector is screwed or pushed into the holder on a vehicle body through the hole on a vehicle license plate, either part of the protector or holder is expanded or pressed or both parts of the protector and holder are expanded or pressed. After the protector is placed in the holder, then the expanded or/and pressed parts return. The returned position makes the protector to be held or connected by the holder. The protector is held by the holder firmly by spring or screw. The protector can not be taken out by screwing or pulling from the outside of the vehicle body for protecting the vehicle license plate from the being stolen. The connection between the protector and its holder is released from the inside chamber of the vehicle body. The protector is pulled or screwed out from the outside of the vehicle body. If there is no the inside chamber, the protector is release from its holder with a special releasing tool, which can be manufactured. The holder, which usually locates on rear side of a vehicle bumper, may be made to have a protection function for the protector. Only a special tool is used to release the protector from the holder. Then the vehicle plate is to be changed. The protector or holder may be used for one or more than one time.

The plate protection consists a protector and its holder. The holder may be an additional holder, the existing or new hole or screw holder on a vehicle body with one or two pieces. When the existing holder or hole on a vehicle body is used as the holder, the protection consists one piece as the protector. When an additional holder to meet some situation is used, the protection consists two pieces. The protector with the existing hole or the existing screw holder on a vehicle body is usually at the least cost, which may be less than 25 cents.

There are several methods to make either part of the protector or holder to be expanded or pressed or both parts of the protector and holder to be expanded or pressed. One method is to make the protector to have some difference compared with the existing regular plate screw. The existing regular plate screw, which looks the same shape as a normal screw, has two parts. The top part of the plate screw has a larger diameter than the hole diameter of the existing vehicle license plate. The rest part is the screw with about ¼ inch diameter. The protector in this method has three parts. The top part, which is some short, is almost the same as the regular plate screw. The middle part of the protector has a smaller diameter or size compared with the internal diameter or size of the holder. The bottom part of the protector is a screw, which has a larger diameter or size compared with the internal diameter or size of the holder. The diameter of the bottom part of the protector reduces to the bottom end gradually. The protector is made from metal, plastic or other materials. The holder is made to have some cuts such as cross cuts or the cuts at 120 degree from the bottom part of the holder. When the protector is pushed or screwed through the hole of a vehicle license plate and into the holder, the holder on a vehicle body has the expanded function. The holder expands to some larger diameter or size because of the cuts. After the bottom part of the protector passes the holder, the holder bottom part returns to the original position because the middle part of the protector has a smaller diameter or size compared with the internal diameter or size of the holder. The protector has both functions of protection and screw. The holder may be made from metal or plastic. Metal or plastic part itself has the function to be expanded or pressed to certain degree. The second method is to make some cuts such as cross cuts or the cuts at 120 degree from the bottom of the protector. So the bottom part of the protector is pressed during screwing or pushing into a holder or hole on a vehicle body. After the bottom part of the protector passes the holder or hole, the pressed bottom part of the protector expands and returns to the original position and holds or connects with the holder or hole because the bottom part of the protector has a small diameter or size during press and a large diameter or size after returning to the original position. The protector is screwed into the holder or hole on the vehicle body to hold the plate firmly. The third method is to make the protector to have three parts. The top part, which is some short, is almost the same as the regular plate screw. The middle part of the protector has a smaller diameter or size compared with the diameter or size of the sunken hole on the holder. The bottom part of the protector is a nail tail, which has a larger diameter or size compared with the diameter of the sunken hole on the holder. The diameter reduces to the bottom end of the protector gradually. The protector and holder may be made from metal. The holder sheet is made to have some cuts such as cross cuts or the cuts at 60 degree on the holder sheet. There is a sunken hole in the center on the holder sheet. The holder also has a cover part, which makes the bottom part of the protector not visible after connecting the protector and holder together. The protector is pushed through the hole of a vehicle license plate and screwed into the hole on a truck bumper to hold the license plate. Then the sunken hole on the holder is pushed against the bottom part of the protector. When the holder sheet passes the bottom part of protector, the protector is connected with the holder, which can not be released except with a special tool. The special tool can be made to have the function to expand the sunken hole on the holder. The holder may be used once or more than one time. The fourth method is to make the protector into a two-nails shape with two tails together, which is a special situation for the cross cuts and removing the two opposite tails. The tails look similar to the case in the third method. The diameter or size of the bottom part is larger than the diameter or size of the middle part of the protector. There is a fine intercept between them. So the two tails do not contact each other during the press in the opposite directions, which makes the diameter or size of the protector bottom part to become smaller during the press and larger after returning to the original position. The protector is to be held with the holder or hole on a vehicle body. The fifth method is to add some additional parts such as a spring may be used to make the holder to have the function to be pressed or expanded. The sixth method is to make both the protector and holder to have the function to be pressed or expanded. The purpose is to push or screw the protector through the existing hole of a vehicle license plate and into the holder or hole on a vehicle body. Both the protector and holder are pressed or expanded. Then the protector and holder hold each other after returning the original positions. The protector can not be taken away from the outside of the vehicle body. After releasing the protector from the holder from the inside chamber of the vehicle body, which is for most cars and vans, then the protector can be taken out from the outside of the vehicle body. The protector may be used again. When an old vehicle license plate is needed to be changed, the protector is release from the holder after opening the inside chamber of the vehicle body. The protector is screwed or pulled out. Then a new license plate is exchanged. The old or new license plate protector is used. If the hole or holder is located on such as a vehicle bumper without a chamber or cover, which is for most trucks, it may be necessary to have a protection for the protector. So the protector can not be reached or released without authorization. The holder may have a cover part to cover the bottom part of the protector and to protect the protector. Only a special tool is used to release the connection between the protector and the holder.

Another method is to have a protector and an additional holder, which if different from the third method and may meet some different situations. The holder has the screw at one end, which is screwed into a holder or hole on a support body, and the connection at another end to hold the protector. After the connection of the protector is release from the holder, then the protector is screwed or pulled out. The area around the hole on a vehicle license plate can be cut or removed by a metal scissors to make the hole larger than the diameter of the top part of the protector. For a new vehicle license plate, the punched lines around the hole on the vehicle license plate may be made by a manufacturer. Then it is easy to remove the around area according to the punched lines, which does not need a metal scissors. After removing the area around the hole on the vehicle license plate, the vehicle license plate can be removed easily. But the plate is used only once. This method may also be used for other plates.

The cost for the plate protector is low specially when the existing holder or hole on a vehicle body is used. The method in this invention provides a practical and economical protection for automobile industry and vehicle customers to protect the license plates.

### DETAIL DESCRIPTION OF THE PREFERRED EMBODIMENTS

The following examples set forth preferred methods in accordance with the invention. It is to be understood, however, that these examples are provided by way of illustration and nothing therein should be taken as a limitation upon the overall scope of the invention.

### EXAMPLE 1

A vehicle license plate protector comprised three parts. The top part was almost the same as a regular license plate screw. The length was ⅜ inch. The bottom part with screws had the cross cuts, which made the bottom part to be pressed. The middle part had a diameter 3/16 inch, which was smaller than the internal diameter of the existing holder on a car body located in the rear central location. The protector was pushed and screwed through the hole of a car license plate and into the existing holder on the car rear body. The bottom part of the protector was pressed to a smaller diameter during screwing into the holder. After the middle part of the protector was in the holder, the bottom part of the protector passed the holder and the pressed bottom part of the protector returned to the original position. Then the protector could not be taken out from the outside of the car body. Another vehicle license plate protector was used in the same way as above. The two protectors were screwed into the holders to hold the car license plate firmly.

### EXAMPLE 2

A vehicle license plate protector comprised three parts. The top part with ⅜ inch length was almost the same as a regular plate screw. The middle part of the protector had a diameter ⅛ inch. The bottom part of the protector had a diameter 3/16 inch and reduced gradually to a diameter 1/16 inch at the bottom end. The holder with a cover had the cut lines at 60 degree on the holder sheet. There was a sunken hole with a diameter ⅛ inch in the center on the holder sheet. The protector was pushed through the sunken hole of a vehicle license plate and screwed into the hole on a truck bumper to hold the license plate firmly. Then the holder was pushed against the bottom part of the protector. The sunken hole expanded during pushing the bottom part of the protector. Then the protector was connected with the holder after the bottom part of the protector passed the sunken hole, which could not be released without a special tool to expand the sunken hole on the holder.

### EXAMPLE 3

A vehicle license plate protector comprised three parts. The top part was almost the same as a regular license plate screw. The length was ⅜ inch. The bottom part with screws had a diameter ¼ inch and reduced to ⅛ inch. The middle part had a diameter 5/32 inch. A screw holder, which located on a car body located in the rear central location, had an internal diameter 5/32 inch and the cross cuts. The protector was pushed and screwed through the hole of a car license plate and into the holder on the car rear body. The bottom part of the protector was screwed into the holder, which was expanded to a larger diameter during screwing the protector into the holder. After the middle part of the protector was in the holder, the bottom part of the protector passed the holder and the expanded part of the holder returned to the original position. Then the protector could not be taken out from the outside of the car body. The protector was screwed into the holder to hold the car license plate firmly.

### EXAMPLE 4

A plate protector comprised three parts. The top part with ¼ inch length and ¼ inch diameter was the same as a normal screw. The bottom part had the cross cuts, which made the part to be pressed. The diameter of bottom part of the protector reduced from 5/16 inch to 3/16 inch. The diameters of the middle part had a diameter 3/16 inch. A metal sheet had a hole ⅜ inch diameter. A holder was a nut shape with two diameters of ¼ inch and ⅜ inch in the front and back. There was a cover in the back side. There were four releasing holes in the back side on the holder, which were used for releasing the bottom part of the protector from the holder. The protector was pushed through the hole on a plate and the hole on the metal sheet. The metal sheet was the support to the plate. Then the holder was pushed against the bottom part of the protector. The bottom part of the protector was pressed to smaller diameter during pushing into the holder. After the middle part of the protector was in the holder and the pressed bottom part of the protector returned to the original position with the larger diameter, the bottom part of the protector located in the back side of the holder with the diameter ⅜ inch. Then the protector could not be taken out from the both sides of the metal sheet. The holder was screwed onto the top part of the protector to hold the protector, plate, metal sheet, and holder firmly.

### EXAMPLE 5

A plate protector comprised three parts. The top part with ¼ inch length and ¼ inch diameter was the same as a normal screw. The bottom part with screws had the cross cuts, which made the part to be pressed. The diameter of bottom part of the protector reduced from 5/16 inch to 3/16 inch. The diameters of the middle part had a diameter 3/16 inch. The holder had a screw at one end. The holder was screwed onto a wood sheet. The protector was pushed and screwed through the hole on a plate and into the holder. The bottom part of the protector was pressed to smaller diameter during screwing into the holder. After the middle part of the protector was in the holder and the pressed bottom part of the protector returned to the original position, the protector was held with the holder. Then the top part was screwed into the holder to hold the plate firmly. Then the protector and plate could not be taken out from the holder.

What is claimed is:

1. A method of protecting a vehicle license plate by a protector and a holder with pressed or expanded function comprising to screw or push the protector through the hole on a vehicle license plate and into the holder on a vehicle body to hold the protector, plate and holder together after the pressed or expanded part reruns for protecting the plate from being stolen.

2. The method of claim 1 wherein the holder on a vehicle body is the existing hole or holder on a vehicle body or an additional holder.

3. The method of claim 1 wherein the protector has or has not a function to be pressed or expanded.

4. The method of claim 1 wherein the holder has or has not a function to be pressed or expanded.

5. The method of claim 1 wherein the protector is held by the holder firmly by a spring or screw.

6. The method of claim 1 wherein the protector is not taken out from the holder without releasing the connection between the protector and holder.

7. The method of claim 1 wherein a special tool is used to release the connection between the protector and holder.

8. A product for protecting a vehicle license plate, plate frame or cover plate according to the method of claim 1.

9. A product for releasing the connection between the protector and holder according to the method of claim 1.

10. A method of protecting a plate by a protector and a holder with pressed or expanded function comprising to screw or push the protector through the hole on a plate and into the holder on a support body to hold the protector, plate and holder together after the pressed or expanded part reruns for protecting the plate from being stolen.

11. The method of claim 10 wherein the holder on a support body is the existing hole or holder on a support body or an additional holder.

12. The method of claim 10 wherein the protector has or has not a function to be pressed or expanded.

13. The method of claim 10 wherein the holder has or has not a function to be pressed or expanded.

14. The method of claim 10 wherein the protector is held by the holder firmly by a spring or screw.

15. The method of claim 10 wherein the protector is not taken out from the holder without releasing the connection between the protector and the holder.

16. The method of claim 10 wherein a special tool is used to release the connection between the protector and holder

17. A product for protecting a plate according to the method of claim 10.

18. A product for releasing the connection between the protector and holder according to the method of claim 10.
